(19) United States
(12) Patent Application Publication
(10) Pub. No.: US 2025/0238258 A1
(43) Pub. Date: Jul. 24, 2025

(54) STORAGE SYSTEM WITH ADAPTIVE PRIORITIZATION OF BACKGROUND PROCESSES

(71) Applicant: Dell Products L.P., Round Rock, TX (US)

(72) Inventors: Rivka Mayraz Matosevich, Zichron Ya'acov (IL); Dvir Koren, Nahalal (IL); Eran Bida, Ganey Tikva (IL)

(21) Appl. No.: 18/419,012

(22) Filed: Jan. 22, 2024

(51) Int. Cl. G06F 9/48

(52) U.S. Cl. CPC G06F 9/48

(57) ABSTRACT

An apparatus in an illustrative embodiment comprises at least one processing device that includes a processor coupled to a memory. The at least one processing device is configured to determine current state information of a storage system, the current state information being indicative of at least an amount of input-output operations being generated by at least one host device for delivery to the storage system over a network, and to dynamically adjust a rate at which one or more background processes are permitted to generate additional input-output operations based at least in part on the current state information of the storage system. Dynamically adjusting a rate at which one or more background processes are permitted to generate additional input-output operations based at least in part on the current state information may comprise, for example, modifying respective rate limits for one or more of the background processes.

### FIELD

The field relates generally to information processing systems, and more particularly to storage in information processing systems.

### BACKGROUND

Information processing systems often include distributed storage systems comprising multiple storage nodes. These distributed storage systems are often dynamically reconfigurable under software control in order to adapt the number and type of storage nodes and the corresponding system storage capacity as needed, in an arrangement commonly referred to as a software-defined storage system. For example, in a typical software-defined storage system, storage capacities of multiple distributed storage nodes are pooled together into one or more storage pools. For applications running on a host device that utilizes the software-defined storage system, such a storage system provides a logical storage object view to allow a given application to store and access data, without the application being aware that the data is being dynamically distributed among different storage nodes. These and other software-defined storage system arrangements often utilize advanced storage access protocols such as Non-Volatile Memory Express (NVMe) over Fabrics, also referred to as NVMe-oF, or NVMe over Transmission Control Protocol (TCP), also referred to as NVMe/TCP.

### SUMMARY

Conventional storage system arrangements often have difficulty balancing the handling of host input-output (IOs) with additional IOs generated by one or more background processes, such as drive rebuild processes, garbage collection processes and/or replication processes, leading to potentially significant performance degradations.

Illustrative embodiments disclosed herein overcome these and other drawbacks of conventional practice by providing techniques for adaptive prioritization of background processes in a software-defined storage system or other type of distributed storage system.

Such techniques advantageously facilitate the effective execution of background processes of various types in a manner that dynamically avoids interfering with proper execution of host IO operations. Accordingly, potentially significant performance degradations that might otherwise occur when executing one or more background processes are prevented, leading to improved overall performance.

Although some embodiments are described herein in the context of implementing an NVMe-oF or NVMe/TCP access protocol in a software-defined storage system, it is to be appreciated that other embodiments can be implemented in other types of distributed storage systems using other storage access protocols.

In addition, the disclosed techniques can be implemented in other embodiments in stand-alone storage arrays or other types of storage systems that are not distributed across multiple storage nodes. Accordingly, the disclosed techniques are applicable to a wide variety of different types of storage systems.

In one embodiment, an apparatus comprises at least one processing device that includes a processor coupled to a memory. The at least one processing device is configured to determine current state information of a storage system, the current state information being indicative of at least an amount of IO operations being generated by at least one host device for delivery to the storage system over a network, and to dynamically adjust a rate at which one or more background processes are permitted to generate additional IO operations based at least in part on the current state information of the storage system. The at least one processing device illustratively comprises at least a portion of the storage system.

In some embodiments, the current state information indicates at least one of an IO operations per second (IOPS) measure and a bandwidth measure for the IO operations generated by the at least one host device. Additional or alternative measures, parameters, indicators or other types of information can be used to characterize current state of a storage system in other embodiments.

Dynamically adjusting a rate at which one or more background processes are permitted to generate additional IO operations based at least in part on the current state information in some embodiments illustratively comprises modifying respective rate limits for one or more of the background processes.

In some embodiments, the current state information includes both an indication of the amount of IO operations being generated by the at least one host device and respective additional indications of amounts of IO operations being generated by each of a plurality of background processes.

By way of example, in some embodiments, responsive to a detected condition in which the amount of IO operations being generated by the at least one host device is below a threshold, a rate at which at least one of the plurality of background processes is permitted to generate additional IO operations is dynamically increased.

As another example, in some embodiments, responsive to a detected condition in which the amount of IO operations being generated by the at least one host device is above a threshold, a rate at which at least one of the plurality of background processes is permitted to generate additional IO operations is dynamically decreased.

Additionally or alternatively, dynamically adjusting a rate at which one or more background processes are permitted to generate additional IO operations based at least in part on the current state information in some embodiments comprises controlling amounts of IO operations being generated by respective ones of a plurality of background processes subject to a combined rate limit on the amount of IO operations being generated by the at least one host device and the amounts of IO operations being generated by respective ones of the plurality of background processes.

The combined rate limit for the IO operations of the at least one host device and the plurality of background processes is set in some embodiments in terms of a percentage of a median bandwidth of IO operations for the storage system as determined over one or more monitoring periods. A wide variety of other types of individual or combined rate limits can be used in other embodiments.

In some embodiments, a given one of the background processes comprises a drive rebuild process, and the current state information includes an indication of whether or not a maximum number of failed drives has been reached. In such an embodiment, dynamically adjusting a rate at which one or more background processes are permitted to generate additional IO operations based at least in part on the current state information illustratively comprises dynamically increasing a rate of the drive rebuild process based at least in part on the maximum number of failed drives being reached.

Additionally or alternatively, such an embodiment can dynamically increase a rate of the drive rebuild process based at least in part on an indication of how close the storage system is to the maximum number of failed drives.

As another example, a given one of the background processes in some embodiments comprises a garbage collection process, and the current state information includes an indication of whether or not an amount of available storage capacity is below a threshold. In such an embodiment, dynamically adjusting a rate at which one or more background processes are permitted to generate additional IO operations based at least in part on the current state information illustratively comprises dynamically increasing a rate of the garbage collection process based at least in part on the amount of available storage capacity being below the threshold.

As yet another example, a given one of the background processes in some embodiments comprises a replication process, and the current state information includes an indication of whether or not an amount of time remaining to a replication deadline is below a threshold. In such an embodiment, dynamically adjusting a rate at which one or more background processes are permitted to generate additional IO operations based at least in part on the current state information illustratively comprises dynamically increasing a rate of the replication process based at least in part on the amount of time remaining to the replication deadline being below the threshold.

Numerous other types and arrangements of background processes, current state information and dynamic rate adjustments can be used in other embodiments.

As indicated above, the storage system in some embodiments illustratively comprises a distributed storage system that includes a plurality of storage nodes. The distributed storage system may more particularly comprise, for example, a software-defined storage system in which the storage nodes illustratively comprise respective software-defined storage server nodes of the software-defined storage system. Again, the disclosed techniques can be implemented in a wide variety of other types of storage systems in other embodiments.

These and other illustrative embodiments include, without limitation, apparatus, systems, methods and processor-readable storage media.

### BRIEF DESCRIPTION OF THE DRAWINGS

FIG. 1 is a block diagram of an information processing system incorporating functionality for adaptive prioritization of background processes in a distributed storage system in an illustrative embodiment.

FIG. 2 is a flow diagram of a process for adaptive prioritization of background processes in a storage system in an illustrative embodiment.

FIG. 3 shows an example of an information processing system incorporating functionality for adaptive prioritization of background processes in a software-defined storage system in an illustrative embodiment.

FIG. 4 shows another example of an information processing system incorporating functionality for adaptive prioritization of background processes in an illustrative embodiment.

FIG. 5 shows a further example of an information processing system incorporating functionality for adaptive prioritization of background processes in an illustrative embodiment.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that these and other embodiments are not restricted to the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other cloud-based system that includes one or more clouds hosting multiple tenants that share cloud resources, as well as other types of systems comprising a combination of cloud and edge infrastructure. Numerous different types of enterprise computing and storage systems are also encompassed by the term “information processing system” as that term is broadly used herein.

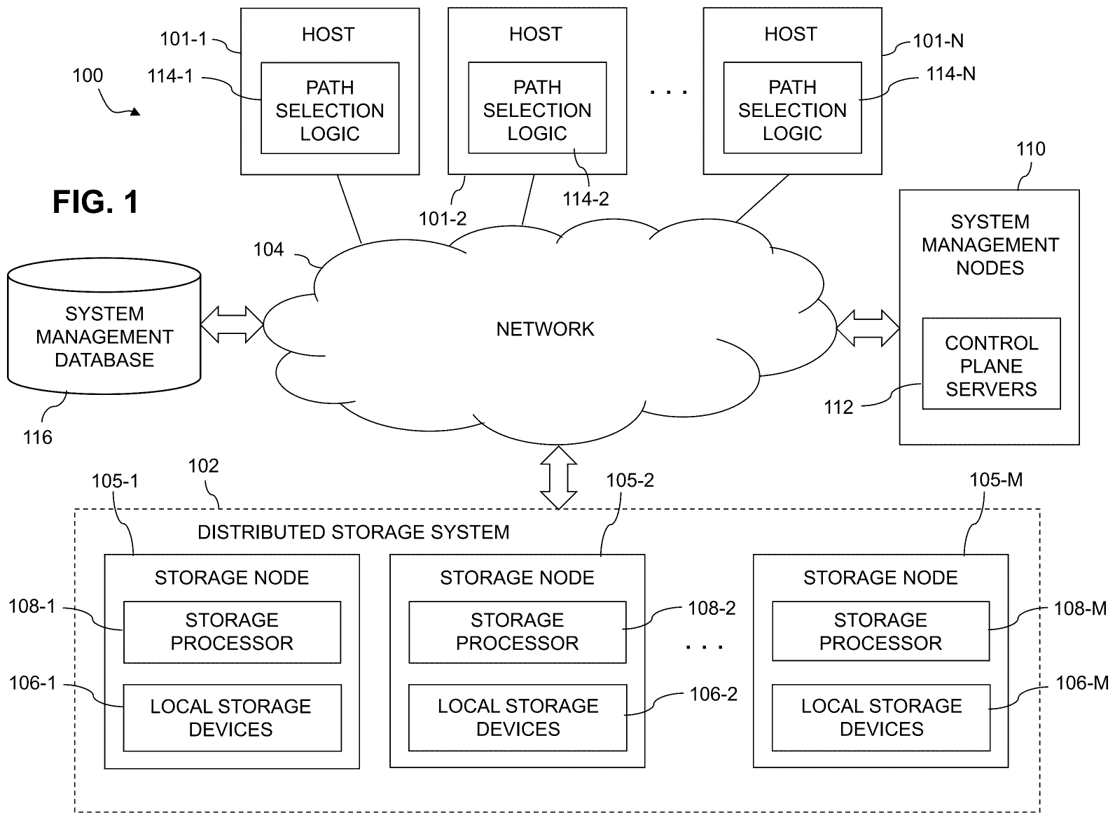

FIG. 1 shows an information processing system 100 configured in accordance with an illustrative embodiment. The information processing system 100 comprises a plurality of hosts 101-1, 101-2, . . . 101-N, collectively referred to herein as hosts 101, and a distributed storage system 102 shared by the hosts 101. The hosts 101 and distributed storage system 102 in this embodiment are configured to communicate with one another via a network 104 that illustratively utilizes protocols such as Transmission Control Protocol (TCP) and Internet Protocol (IP), and therefore network 104 may be viewed as a representative example of a TCP/IP network, although it is to be appreciated that the network 104 can operate using additional or alternative protocols. In some embodiments, the network 104 additionally or alternatively comprises a storage area network (SAN) that includes one or more Fibre Channel (FC) switches, Ethernet switches or other types of switch fabrics.

It should be noted that the term “host” as used herein is intended to be broadly construed, so as to encompass, for example, a host device or a host system, each of which may comprise multiple distinct devices of various types. A host in some embodiments can comprise, for example, at least one server, as well as additional or alternative types and arrangements of processing devices.

The distributed storage system 102 more particularly comprises a plurality of storage nodes 105-1, 105-2, . . . 105-M, collectively referred to herein as storage nodes 105. The values N and M in this embodiment denote arbitrary integer values that in the figure are illustrated as being greater than or equal to three, although other values such as N=1, N=2, M=1 or M=2 can be used in other embodiments.

The storage nodes 105 collectively form the distributed storage system 102, which is just one possible example of what is generally referred to herein as a “distributed storage system.” Other distributed storage systems can include different numbers and arrangements of storage nodes, and possibly one or more additional components. For example, as indicated above, a distributed storage system in some embodiments may include only first and second storage nodes, corresponding to an M=2 embodiment. Some embodiments can configure a distributed storage system to include additional components in the form of a system manager implemented using one or more additional nodes.

In some embodiments, the distributed storage system 102 provides a logical address space that is divided among the storage nodes 105, such that different ones of the storage nodes 105 store the data for respective different portions of the logical address space. Accordingly, in these and other similar distributed storage system arrangements, different ones of the storage nodes 105 have responsibility for different portions of the logical address space. For a given logical storage volume, logical blocks of that logical storage volume are illustratively distributed across the storage nodes 105.

Other types of distributed or non-distributed storage systems can be used in other embodiments. For example, distributed storage system 102 can comprise multiple distinct storage arrays, such as a production storage array and a backup storage array, possibly deployed at different locations. Accordingly, in some embodiments, one or more of the storage nodes 105 may each be viewed as comprising at least a portion of a separate storage array with its own logical identifier (e.g., address) space. Alternatively, the storage nodes 105 can be viewed as collectively comprising one or more storage arrays. The term “storage node” as used herein is therefore intended to be broadly construed.

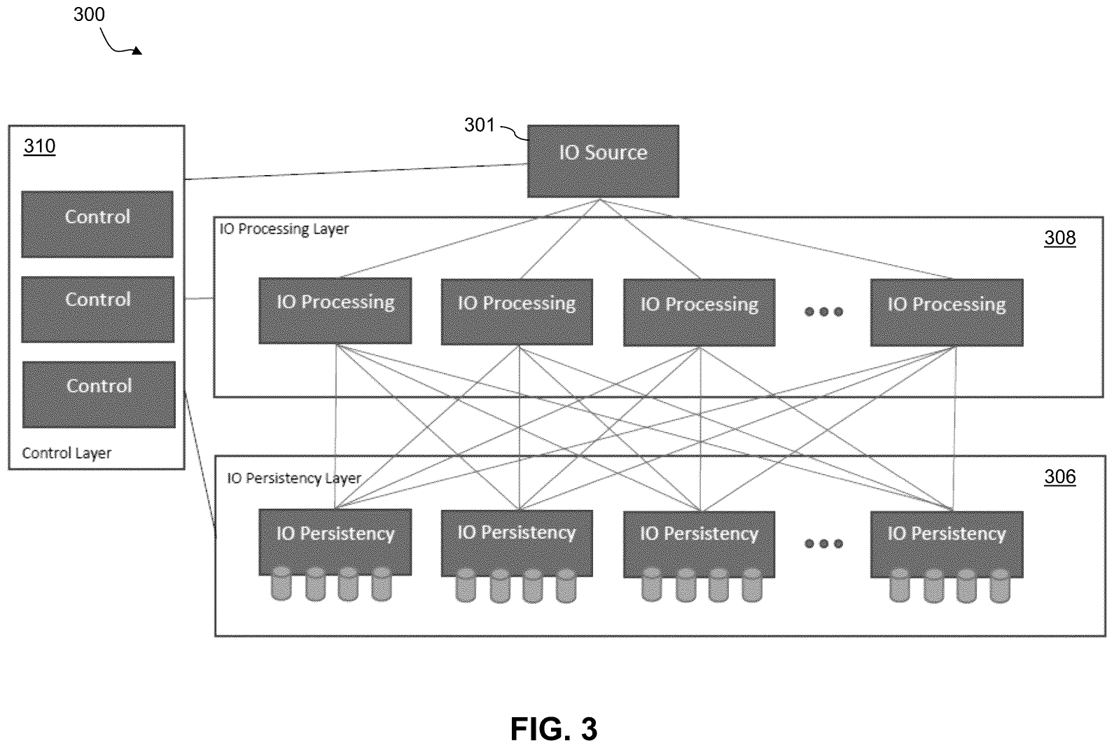

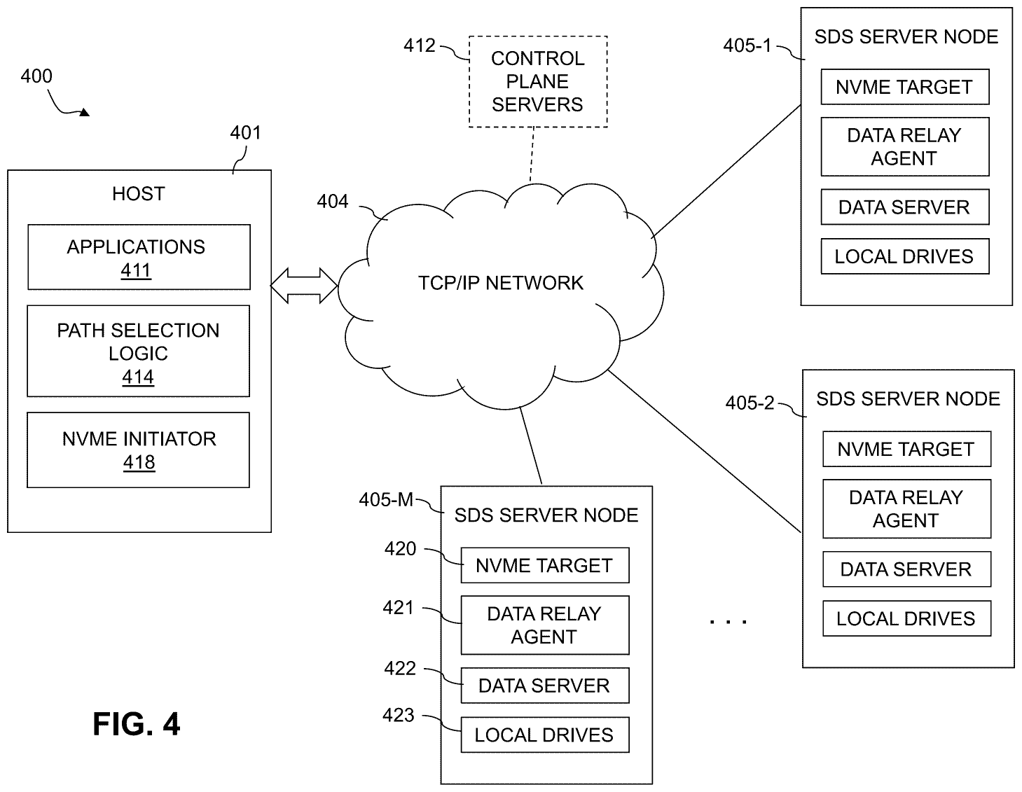

In some embodiments, the distributed storage system 102 comprises a software-defined storage system and the storage nodes 105 comprise respective software-defined storage server nodes of the software-defined storage system, such nodes also being referred to herein as SDS server nodes, where SDS denotes software-defined storage. Accordingly, the number and types of storage nodes 105 can be dynamically expanded or contracted under software control in some embodiments. Examples of such software-defined storage systems will be described in more detail below in conjunction with FIGS. 3 and 4.

It is to be appreciated, however, that the adaptive prioritization techniques disclosed herein can be implemented in other embodiments in stand-alone storage arrays or other types of storage systems that are not distributed across multiple storage nodes. The disclosed techniques are therefore applicable to a wide variety of different types of storage systems. The distributed storage system 102 is just one illustrative example.

In the distributed storage system 102, each of the storage nodes 105 is illustratively configured to interact with one or more of the hosts 101. The hosts 101 illustratively comprise servers or other types of computers of an enterprise computer system, cloud-based computer system or other arrangement of multiple compute nodes, each associated with one or more system users.

The hosts 101 in some embodiments illustratively provide compute services such as execution of one or more applications on behalf of each of one or more users associated with respective ones of the hosts 101. Such applications illustratively generate input-output (IO) operations that are processed by a corresponding one of the storage nodes 105. The term “input-output” as used herein refers to at least one of input and output. For example, IO operations may comprise write requests and/or read requests directed to logical addresses of a particular logical storage volume of one or more of the storage nodes 105. These and other types of IO operations are also generally referred to herein as IO requests.

The IO operations that are currently being processed in the distributed storage system 102 in some embodiments are referred to herein as outstanding IOs that have been admitted by the storage nodes 105 to further processing within the system 100. The storage nodes 105 are illustratively configured to queue IO operations arriving from one or more of the hosts 101 in one or more sets of IO queues.

The storage nodes 105 illustratively comprise respective processing devices of one or more processing platforms. For example, the storage nodes 105 can each comprise one or more processing devices each having a processor and a memory, possibly implementing virtual machines and/or containers, although numerous other configurations are possible.

The storage nodes 105 can additionally or alternatively be part of cloud infrastructure, such as a cloud-based system implementing Storage-as-a-Service (STaaS) functionality.

The storage nodes 105 may be implemented on a common processing platform, or on separate processing platforms. In the case of separate processing platforms, there may be a single storage node per processing platform or multiple storage nodes per processing platform.

The hosts 101 are illustratively configured to write data to and read data from the distributed storage system 102 comprising storage nodes 105 in accordance with applications executing on those hosts 101 for system users.

The term “user” herein is intended to be broadly construed so as to encompass numerous arrangements of human, hardware, software or firmware entities, as well as combinations of such entities. Compute and/or storage services may be provided for users under a Platform-as-a-Service (PaaS) model, an Infrastructure-as-a-Service (IaaS) model and/or a Function-as-a-Service (FaaS) model, although it is to be appreciated that numerous other cloud infrastructure arrangements could be used. Also, illustrative embodiments can be implemented outside of the cloud infrastructure context, as in the case of a stand-alone computing and storage system implemented within a given enterprise. Combinations of cloud and edge infrastructure can also be used in implementing a given information processing system to provide services to users.

Communications between the components of system 100 can take place over additional or alternative networks, including a global computer network such as the Internet, a wide area network (WAN), a local area network (LAN), a satellite network, a telephone or cable network, a cellular network such as 4G or 5G cellular network, a wireless network such as a WiFi or WiMAX network, or various portions or combinations of these and other types of networks. The system 100 in some embodiments therefore comprises one or more additional networks other than network 104 each comprising processing devices configured to communicate using TCP, IP and/or other communication protocols.

As a more particular example, some embodiments may utilize one or more high-speed local networks in which associated processing devices communicate with one another utilizing Peripheral Component Interconnect express (PCIe) interface cards of those devices, that support networking protocols such as InfiniBand or Fibre Channel, in addition to or in place of TCP/IP. Numerous alternative networking arrangements are possible in a given embodiment, as will be appreciated by those skilled in the art. Additional examples include remote direct memory access (RDMA) over Converged Ethernet (RoCE) or RDMA over iWARP.

The first storage node 105-1 comprises a plurality of storage devices 106-1 and an associated storage processor 108-1. The storage devices 106-1 illustratively store metadata pages and user data pages associated with one or more storage volumes of the distributed storage system 102. The storage volumes illustratively comprise respective logical units (LUNs) or other types of logical storage volumes (e.g., NVMe namespaces). The storage devices 106-1 in some embodiments more particularly comprise respective local persistent storage devices of the first storage node 105-1. Such persistent storage devices are local to the first storage node 105-1, but remote from the second storage node 105-2, the storage node 105-M and any other ones of other storage nodes 105.

Each of the other storage nodes 105-2 through 105-M is assumed to be configured in a manner similar to that described above for the first storage node 105-1. Accordingly, by way of example, storage node 105-2 comprises a plurality of storage devices 106-2 and an associated storage processor 108-2, and storage node 105-M comprises a plurality of storage devices 106-M and an associated storage processor 108-M.

As indicated previously, the storage devices 106-2 through 106-M illustratively store metadata pages and user data pages associated with one or more storage volumes of the distributed storage system 102, such as the above-noted LUNs or other types of logical storage volumes. The storage devices 106-2 more particularly comprise local persistent storage devices of the storage node 105-2. Such persistent storage devices are local to the storage node 105-2, but remote from the first storage node 105-1, the storage node 105-M, and any other ones of the storage nodes 105. Similarly, the storage devices 106-M more particularly comprise local persistent storage devices of the storage node 105-M. Such persistent storage devices are local to the storage node 105-M, but remote from the first storage node 105-1, the second storage node 105-2, and any other ones of the storage nodes 105.

The local persistent storage of a given one of the storage nodes 105 therefore illustratively comprises the particular local persistent storage devices that are implemented in or otherwise associated with that storage node.

The storage processors 108 of the storage nodes 105 may be implemented as or otherwise comprise, for example, respective storage controllers, directors or other storage system components configured to control storage system operations relating to processing of IO operations. The storage processors 108 can include additional modules and other components typically found in conventional implementations of such storage processors, although such additional modules and other components are omitted from the figure for clarity and simplicity of illustration.

Additionally or alternatively, the storage processors 108 in some embodiments can comprise or be otherwise associated with one or more write caches and one or more write cache journals, both also illustratively distributed across the storage nodes 105 of the distributed storage system. It is further assumed in illustrative embodiments that one or more additional journals are provided in the distributed storage system, such as, for example, a metadata update journal and possibly other journals providing other types of journaling functionality for IO operations. Illustrative embodiments disclosed herein are assumed to be configured to perform various destaging processes for write caches and associated journals, and to perform additional or alternative functions in conjunction with processing of IO operations.

The storage devices 106 of the storage nodes 105 illustratively comprise solid state drives (SSDs). Such SSDs are implemented using non-volatile memory (NVM) devices such as flash memory. Other types of NVM devices that can be used to implement at least a portion of the storage devices 106 include non-volatile random access memory (NVRAM), phase-change RAM (PC-RAM), magnetic RAM (MRAM), resistive RAM, and spin torque transfer magneto-resistive RAM (STT-MRAM). These and various combinations of multiple different types of NVM devices may also be used. For example, hard disk drives (HDDs) can be used in combination with or in place of SSDs or other types of NVM devices.

However, it is to be appreciated that other types of storage devices can be used in other embodiments. For example, a given storage system as the term is broadly used herein can include a combination of different types of storage devices, as in the case of a multi-tier storage system comprising a flash-based fast tier and a disk-based capacity tier. In such an embodiment, each of the fast tier and the capacity tier of the multi-tier storage system comprises a plurality of storage devices with different types of storage devices being used in different ones of the storage tiers. For example, the fast tier may comprise flash drives while the capacity tier comprises HDDs. The particular storage devices used in a given storage tier may be varied in other embodiments, and multiple distinct storage device types may be used within a single storage tier. The term “storage device” as used herein is intended to be broadly construed, so as to encompass, for example, SSDs, HDDs, flash drives, hybrid drives or other types of storage devices. Such storage devices are examples of local persistent implementations of storage devices 106 of the storage nodes 105 of the distributed storage system of FIG. 1.

In some embodiments, the storage nodes 105 collectively provide a distributed storage system, although the storage nodes 105 can be used to implement other types of storage systems in other embodiments. One or more such storage nodes can be associated with at least one storage array. Additional or alternative types of storage products that can be used in implementing a given storage system in illustrative embodiments include software-defined storage, cloud storage and object-based storage. Combinations of multiple ones of these and other storage types can also be used.

Although the storage nodes 105 are illustrated in FIG. 1 as including both the storage devices 106 and the storage processors 108, this is by way of example only, and in other embodiments, the storage devices 106 and the storage processors 108 may be on separate nodes. For example, the system 100 in other embodiments can comprise one or more storage processor nodes and one or more storage device nodes, with the storage processor nodes and the storage device nodes being configured to communicate with one another over one or more networks. In such embodiments, the number of storage processor nodes can be different than the number of storage device nodes. These and numerous other storage node configurations can be utilized in a storage system as that term is broadly defined herein.

As indicated above, the storage nodes 105 in some embodiments comprise respective software-defined storage server nodes of a software-defined storage system, in which the number and types of storage nodes 105 can be dynamically expanded or contracted under software control using software-defined storage techniques.

The term “storage system” as used herein is therefore intended to be broadly construed, and should not be viewed as being limited to certain types of storage systems, such as content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

In some embodiments, communications between the hosts 101 and the storage nodes 105 comprise NVMe commands of an NVMe storage access protocol, for example, as described in the NVMe Specification, Revision 2.0c, October 2022, which is incorporated by reference herein. Other examples of NVMe storage access protocols that may be utilized in illustrative embodiments disclosed herein include NVMe over Fabrics, also referred to herein as NVMe-oF, and NVMe over TCP, also referred to herein as NVMe/TCP. Other embodiments can utilize other types of storage access protocols. As another example, communications between the hosts 101 and the storage nodes 105 in some embodiments can comprise Small Computer System Interface (SCSI) commands and the Internet SCSI (iSCSI) protocol.

Other types of commands may be used in other embodiments, including commands that are part of a standard command set, or custom commands such as a “vendor unique command” or VU command that is not part of a standard command set. The term “command” as used herein is therefore intended to be broadly construed, so as to encompass, for example, a composite command that comprises a combination of multiple individual commands. Numerous other types, formats and configurations of IO operations can be used in other embodiments, as that term is broadly used herein.

Some embodiments disclosed herein are configured to utilize one or more RAID arrangements to store data across the storage devices 106 in each of one or more of the storage nodes 105 of the distributed storage system 102. Other embodiments can utilize other data protection techniques, such as, for example, Erasure Coding (EC), instead of one or more RAID arrangements.

The RAID arrangement can comprise, for example, a RAID 5 arrangement supporting recovery from a failure of a single one of the plurality of storage devices, a RAID 6 arrangement supporting recovery from simultaneous failure of up to two of the storage devices, or another type of RAID arrangement. For example, some embodiments can utilize RAID arrangements with redundancy higher than two.

The term “RAID arrangement” as used herein is intended to be broadly construed, and should not be viewed as limited to RAID 5, RAID 6 or other parity RAID arrangements. For example, a RAID arrangement in some embodiments can comprise combinations of multiple instances of distinct RAID approaches, such as a mixture of multiple distinct RAID types (e.g., RAID 1 and RAID 6) over the same set of storage devices, or a mixture of multiple stripe sets of different instances of one RAID type (e.g., two separate instances of RAID 5) over the same set of storage devices. Other types of parity RAID techniques and/or non-parity RAID techniques can be used in other embodiments.

Such a RAID arrangement is illustratively established by the storage processors 108 of the respective storage nodes 105. The storage devices 106 in the context of RAID arrangements herein are also referred to as “disks” or “drives.” A given such RAID arrangement may also be referred to in some embodiments herein as a “RAID array.” The RAID arrangement used in an illustrative embodiment includes a plurality of devices, each illustratively a different physical storage device of the storage devices 106. Multiple such physical storage devices are typically utilized to store data of a given LUN or other logical storage volume in the distributed storage system. For example, data pages or other data blocks of a given LUN or other logical storage volume can be “striped” along with its corresponding parity information across multiple ones of the devices in the RAID arrangement in accordance with RAID 5 or RAID 6 techniques.

A given RAID 5 arrangement defines block-level striping with single distributed parity and provides fault tolerance of a single drive failure, so that the array continues to operate with a single failed drive, irrespective of which drive fails. For example, in a conventional RAID 5 arrangement, each stripe includes multiple data blocks as well as a corresponding p parity block. The p parity blocks are associated with respective row parity information computed using well-known RAID 5 techniques. The data and parity blocks are distributed over the devices to support the above-noted single distributed parity and its associated fault tolerance.

A given RAID 6 arrangement defines block-level striping with double distributed parity and provides fault tolerance of up to two drive failures, so that the array continues to operate with up to two failed drives, irrespective of which two drives fail. For example, in a conventional RAID 6 arrangement, each stripe includes multiple data blocks as well as corresponding p and q parity blocks. The p and q parity blocks are associated with respective row parity information and diagonal parity information computed using well-known RAID 6 techniques. The data and parity blocks are distributed over the devices to collectively provide a diagonal-based configuration for the p and q parity information, so as to support the above-noted double distributed parity and its associated fault tolerance.

In such RAID arrangements, the parity blocks are typically not read unless needed for a rebuild process triggered by one or more storage device failures.

These and other references herein to RAID 5, RAID 6 and other particular RAID arrangements are only examples, and numerous other RAID arrangements can be used in other embodiments. Also, other embodiments can store data across the storage devices 106 of the storage nodes 105 without using RAID arrangements.

In some embodiments, the storage nodes 105 of the distributed storage system of FIG. 1 are connected to each other in a full mesh network, and are collectively managed by a system manager. A given set of storage devices 106 on a given one of the storage nodes 105, such as local persistent storage devices, is illustratively implemented in a disk array enclosure (DAE) or other type of storage array enclosure of that storage node. Each of the storage nodes 105 illustratively comprises a CPU or other type of processor, a memory, a network interface card (NIC) or other type of network interface, and its corresponding storage devices 106, possibly arranged as part of a DAE of the storage node.

In some embodiments, different ones of the storage nodes 105 are associated with the same DAE or other type of storage array enclosure. The system manager is illustratively implemented as a management module or other similar management logic instance, possibly running on one or more of the storage nodes 105, on another storage node and/or on a separate non-storage node of the distributed storage system.

As a more particular non-limiting illustration, the storage nodes 105 in some embodiments are paired together in an arrangement referred to as a “brick,” with each such brick being coupled to a different DAE comprising multiple drives, and each node in a brick being connected to the DAE and to each drive through a separate connection. The system manager may be running on one of the two nodes of a first one of the bricks of the distributed storage system. Again, numerous other arrangements of the storage nodes are possible in a given distributed storage system as disclosed herein.

The system 100 as shown further comprises a plurality of system management nodes 110 that are illustratively configured to provide system management functionality of the type noted above. Such functionality in the present embodiment illustratively further involves utilization of control plane servers 112 and a system management database 116. In some embodiments, at least portions of the system management nodes 110 and their associated control plane servers 112 are distributed over the storage nodes 105. For example, a designated subset of the storage nodes 105 can each be configured to include a corresponding one of the control plane servers 112. Other system management functionality provided by system management nodes 110 can be similarly distributed over a subset of the storage nodes 105.

The system management database 116 stores configuration and operation information of the system 100 and portions thereof are illustratively accessible to various system administrators such as host administrators and storage administrators. Although the system management database 116 is illustratively shown in the figure as being separate from the system management nodes 110, this is by way of example only. In other embodiments, at least portions of the system management database 116 can be implemented within one or more of the system management nodes 110. These and numerous other possible arrangements of system management nodes 110 and other management-related components of the system 100 such as system management database 116 will be apparent to those skilled in the art.

The hosts 101-1, 101-2, . . . 101-N include respective instances of path selection logic 114-1, 114-2, . . . 114-N. Such instances of path selection logic 114 are illustratively utilized in determining paths for delivery of IO operations from their respective hosts 101 to particular ones of the storage nodes 105 of the distributed storage system 102. In some embodiments, the instances of path selection logic 114 are associated with respective instances of host-side adaptive prioritization logic, configured to interact with storage-side adaptive prioritization logic instances implemented in respective one of the storage processors 108 of the storage nodes 105, in providing adaptive prioritization functionality for background processes in the distributed storage system 102 as described in more detail below.

In some embodiments, each of the storage nodes 105 of the distributed storage system 102 is assumed to comprise multiple controllers associated with a corresponding target of that storage node. Such a “target” as that term is broadly used herein is illustratively a destination end of one or more paths from one or more of the hosts 101 to the storage node, and may comprise, for example, an NVMe subsystem of the storage node, although other types of targets can be used in other embodiments. It should be noted that different types of targets may be present in NVMe embodiments than are present in other embodiments that use other storage access protocols, such as SCSI embodiments. Accordingly, the types of targets that may be implemented in a given embodiment can vary depending upon the particular storage access protocol being utilized in that embodiment, and/or other factors. Similarly, the types of initiators can vary depending upon the particular storage access protocol, and/or other factors. Again, terms such as “initiator” and “target” as used herein are intended to be broadly construed, and should not be viewed as being limited in any way to particular types of components associated with any particular storage access protocol.

The paths that are selected by instances of path selection logic 114 of the hosts 101 for delivering IO operations from the hosts 101 to the distributed storage system 102 are associated with respective initiator-target pairs, as described in more detail elsewhere herein.

In some embodiments, IO operations are processed in the hosts 101 utilizing their respective instances of path selection logic 114 in the following manner. A given one of the hosts 101 establishes a plurality of paths between at least one initiator of the given host and a plurality of targets of respective storage nodes 105 of the distributed storage system 102. For each of a plurality of IO operations generated in the given host for delivery to the distributed storage system 102, the host selects a path to a particular target, and sends the IO operation to the corresponding storage node over the selected path.

The given host above is an example of what is more generally referred to herein as “at least one processing device” that includes a processor coupled to a memory. The storage nodes 105 of the distributed storage system 102 are also examples of “at least one processing device” as that term is broadly used herein.

It is to be appreciated that path selection as disclosed herein can be performed independently by each of the hosts 101, illustratively utilizing their respective instances of path selection logic 114, as indicated above, with possible involvement of additional or alternative system components.

In some embodiments, the initiator of the given host and the targets of the respective storage nodes 105 are configured to support one or more designated standard storage access protocols, such as an NVMe access protocol or a SCSI access protocol. As more particular examples in the NVMe context, the designated storage access protocol may comprise an NVMe/FC or NVMe/TCP access protocol, although a wide variety of additional or alternative storage access protocols can be used in other embodiments.

The hosts 101 can comprise additional or alternative components. For example, in some embodiments, the hosts 101 further comprise respective sets of IO queues and respective multi-path input-output (MPIO) drivers. The MPIO drivers collectively comprise a multi-path layer of the hosts 101. Path selection functionality for delivery of IO operations from the hosts 101 to the distributed storage system 102 is provided in the multi-path layer by respective instances of path selection logic 114 implemented within the MPIO drivers. In some embodiments, the instances of path selection logic 114 are implemented at least in part within the MPIO drivers of the hosts 101.

The MPIO drivers may comprise, for example, otherwise conventional MPIO drivers, such as PowerPath® drivers from Dell Technologies, suitably modified in the manner disclosed herein to provide one or more portions of the disclosed functionality for adaptive prioritization of background processes. Other types of MPIO drivers from other driver vendors may be suitably modified to incorporate one or more portions of the functionality for adaptive prioritization of background processes as disclosed herein.

For example, the instances of path selection logic 114 of the respective hosts 101 can be implemented at least in part in respective MPIO drivers of those hosts.

In some embodiments, such instances of path selection logic 114 include or are otherwise associated with respective corresponding instances of host-side adaptive prioritization logic. Such host-side adaptive prioritization logic can be part of an MPIO layer of the hosts 101, or can be implemented elsewhere within the hosts 101.

In some embodiments, the hosts 101 comprise respective local caches, implemented using respective memories of those hosts. A given such local cache can be implemented using one or more cache cards. A wide variety of different caching techniques can be used in other embodiments, as will be appreciated by those skilled in the art. Other examples of memories of the respective hosts 101 that may be utilized to provide local caches include one or more memory cards or other memory devices, such as, for example, an NVMe over PCIe cache card, a local flash drive or other type of NVM storage drive, or combinations of these and other host memory devices.

The MPIO drivers are illustratively configured to deliver IO operations selected from their respective sets of IO queues to the distributed storage system 102 via selected ones of multiple paths over the network 104. The sources of the IO operations stored in the sets of IO queues illustratively include respective processes of one or more applications executing on the hosts 101. For example, IO operations can be generated by each of multiple processes of a database application running on one or more of the hosts 101. Such processes issue IO operations for delivery to the distributed storage system 102 over the network 104. Other types of sources of IO operations may be present in a given implementation of system 100.

A given IO operation is therefore illustratively generated by a process of an application running on a given one of the hosts 101, and is queued in one of the IO queues of the given host with other operations generated by other processes of that application, and possibly other processes of other applications.

The paths from the given host to the distributed storage system 102 illustratively comprise paths associated with respective initiator-target pairs, with each initiator comprising, for example, a port of a single-port or multi-port host bus adaptor (HBA) or other initiating entity of the given host and each target comprising a port or other targeted entity corresponding to one or more of the storage devices 106 of the distributed storage system 102. As noted above, the storage devices 106 illustratively comprise LUNs or other types of logical storage devices.

In some embodiments, the paths are associated with respective communication links between the given host and the distributed storage system 102 with each such communication link having a negotiated link speed. For example, in conjunction with registration of a given HBA to a switch of the network 104, the HBA and the switch may negotiate a link speed. The actual link speed that can be achieved in practice in some cases is less than the negotiated link speed, which is a theoretical maximum value.

Negotiated rates of the respective particular initiator and the corresponding target illustratively comprise respective negotiated data rates determined by execution of at least one link negotiation protocol for an associated one of the paths.

In some embodiments, at least a portion of the initiators comprise virtual initiators, such as, for example, respective ones of a plurality of N-Port ID Virtualization (NPIV) initiators associated with one or more Fibre Channel (FC) network connections. Such initiators illustratively utilize NVMe arrangements such as NVMe/FC, although other protocols can be used. Other embodiments can utilize other types of virtual initiators in which multiple network addresses can be supported by a single network interface, such as, for example, multiple media access control (MAC) addresses on a single network interface of an Ethernet network interface card (NIC). Accordingly, in some embodiments, the multiple virtual initiators are identified by respective ones of a plurality of media MAC addresses of a single network interface of a NIC. Such initiators illustratively utilize NVMe arrangements such as NVMe/TCP, although again other protocols can be used.

Accordingly, in some embodiments, multiple virtual initiators are associated with a single HBA of a given one of the hosts 101 but have respective unique identifiers associated therewith.

Additionally or alternatively, different ones of the multiple virtual initiators are illustratively associated with respective different ones of a plurality of virtual machines of the given host that share a single HBA of the given host, or a plurality of logical partitions of the given host that share a single HBA of the given host.

Numerous alternative virtual initiator arrangements are possible, as will be apparent to those skilled in the art. The term “virtual initiator” as used herein is therefore intended to be broadly construed. It is also to be appreciated that other embodiments need not utilize any virtual initiators. References herein to the term “initiators” are intended to be broadly construed, and should therefore be understood to encompass physical initiators, virtual initiators, or combinations of both physical and virtual initiators.

Various scheduling algorithms, load balancing algorithms and/or other types of algorithms can be utilized by the MPIO driver of the given host in delivering IO operations from the IO queues of that host to the distributed storage system 102 over particular paths via the network 104. Each such IO operation is assumed to comprise one or more commands for instructing the distributed storage system 102 to perform particular types of storage-related functions such as reading data from or writing data to particular logical volumes of the distributed storage system 102. Such commands are assumed to have various payload sizes associated therewith, and the payload associated with a given command is referred to herein as its “command payload.”

A command directed by the given host to the distributed storage system 102 is considered an “outstanding” command until such time as its execution is completed in the viewpoint of the given host, at which time it is considered a “completed” command. The commands illustratively comprise respective NVMe commands, although other command formats, such as SCSI command formats, can be used in other embodiments. In the SCSI context, a given such command is illustratively defined by a corresponding command descriptor block (CDB) or similar format construct. The given command can have multiple blocks of payload associated therewith, such as a particular number of 512-byte SCSI blocks or other types of blocks. Other command formats, e.g., Submission Queue Entry (SQE), are utilized in the NVMe context.

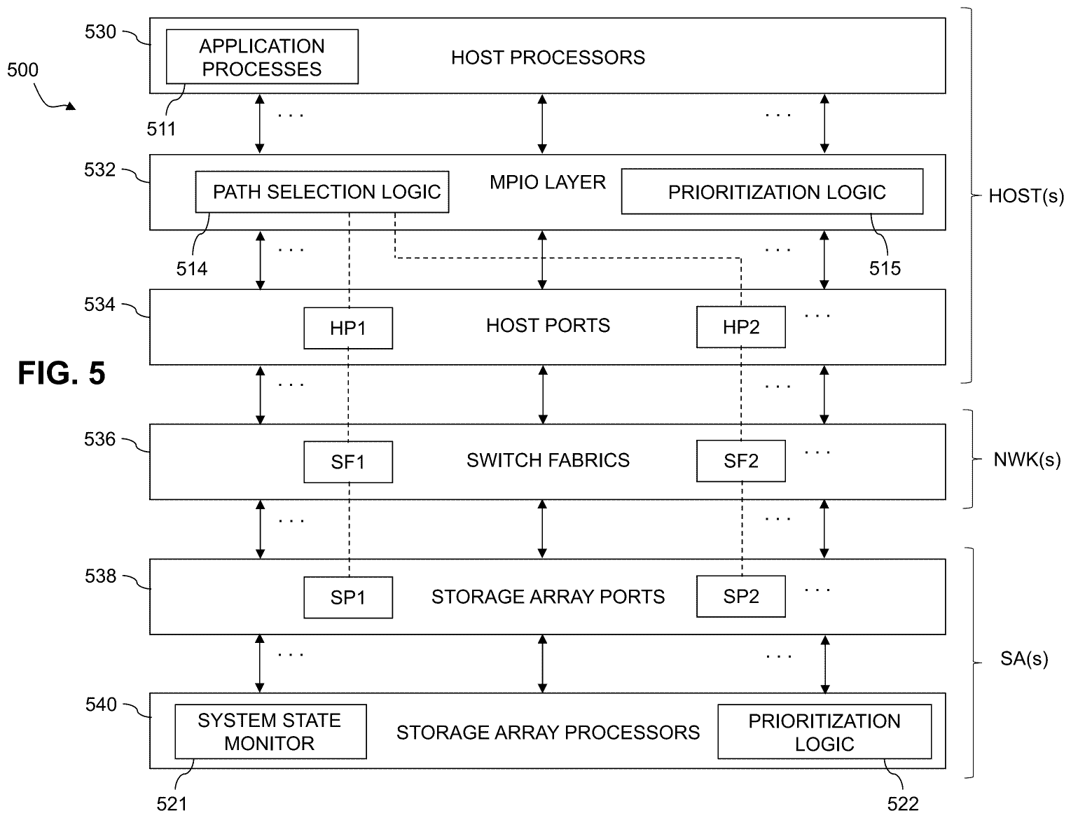

In illustrative embodiments to be described below, it is assumed without limitation that the initiators of a plurality of initiator-target pairs comprise respective ports of the given host and that the targets of the plurality of initiator-target pairs comprise respective ports of the distributed storage system 102. Examples of such host ports and storage array ports are illustrated in conjunction with the embodiment of FIG. 5. The host ports can comprise, for example, ports of single-port HBAs and/or ports of multi-port HBAs, or other types of host ports, including network interface cards (NICs). A wide variety of other types and arrangements of initiators and targets can be used in other embodiments.

Selecting a particular one of multiple available paths for delivery of a selected one of the IO operations from the given host is more generally referred to herein as “path selection.” Path selection as that term is broadly used herein can in some cases involve both selection of a particular IO operation and selection of one of multiple possible paths for accessing a corresponding logical device of the distributed storage system 102. The corresponding logical device illustratively comprises a LUN or other logical storage volume to which the particular IO operation is directed.

It should be noted that paths may be added or deleted between the hosts 101 and the distributed storage system 102 in the system 100. For example, the addition of one or more new paths from the given host to the distributed storage system 102 or the deletion of one or more existing paths from the given host to the distributed storage system 102 may result from respective addition or deletion of at least a portion of the storage devices 106 of the distributed storage system 102.

Addition or deletion of paths can also occur as a result of zoning and masking changes or other types of storage system reconfigurations performed by a storage administrator or other user. Some embodiments are configured to send a predetermined command from the given host to the distributed storage system 102, illustratively utilizing the MPIO driver, to determine if zoning and masking information has been changed. The predetermined command can comprise, for example, a log sense command, a mode sense command, a “vendor unique command” or VU command, or combinations of multiple instances of these or other commands, in an otherwise standardized command format.

In some embodiments, paths are added or deleted in conjunction with addition of a new storage array or deletion of an existing storage array from a storage system that includes multiple storage arrays, possibly in conjunction with configuration of the storage system for at least one of a migration operation and a replication operation.

For example, a storage system may include first and second storage arrays, with data being migrated from the first storage array to the second storage array prior to removing the first storage array from the storage system.

As another example, a storage system may include a production storage array and a recovery storage array, with data being replicated from the production storage array to the recovery storage array so as to be available for data recovery in the event of a failure involving the production storage array.

In these and other situations, path discovery scans may be repeated as needed in order to discover the addition of new paths or the deletion of existing paths.

A given path discovery scan can be performed utilizing known functionality of conventional MPIO drivers, such as PowerPath® drivers.

The path discovery scan in some embodiments may be further configured to identify one or more new LUNs or other logical storage volumes associated with the one or more new paths identified in the path discovery scan. The path discovery scan may comprise, for example, one or more bus scans which are configured to discover the appearance of any new LUNs that have been added to the distributed storage system 102 as well to discover the disappearance of any existing LUNs that have been deleted from the distributed storage system 102.

The MPIO driver of the given host in some embodiments comprises a user-space portion and a kernel-space portion. The kernel-space portion of the MPIO driver may be configured to detect one or more path changes of the type mentioned above, and to instruct the user-space portion of the MPIO driver to run a path discovery scan responsive to the detected path changes. Other divisions of functionality between the user-space portion and the kernel-space portion of the MPIO driver are possible. The user-space portion of the MPIO driver is illustratively associated with an Operating System (OS) kernel of the given host.

For each of one or more new paths identified in the path discovery scan, the given host may be configured to execute a host registration operation for that path. The host registration operation for a given new path illustratively provides notification to the distributed storage system 102 that the given host has discovered the new path.

As indicated previously, the storage nodes 105 of the distributed storage system 102 process IO operations from one or more hosts 101 and in processing those IO operations run various storage application processes that generally involve interaction of that storage node with one or more other ones of the storage nodes.

In the FIG. 1 embodiment, the distributed storage system 102 comprises storage processors 108 and corresponding sets of storage devices 106, and may include additional or alternative components, such as sets of local caches.

The storage processors 108 illustratively control the processing of IO operations received in the distributed storage system 102 from the hosts 101. For example, the storage processors 108 illustratively manage the processing of read and write commands directed by the MPIO drivers of the hosts 101 to particular ones of the storage devices 106. The storage processors 108 can be implemented as respective storage controllers, directors or other storage system components configured to control storage system operations relating to processing of IO operations. In some embodiments, each of the storage processors 108 has a different one of the above-noted local caches associated therewith, although numerous alternative arrangements are possible.

In some embodiments, one or more of the storage nodes 105 each implements at least one target, such as an NVMe target, that is configured to include multiple controllers, such as at least a first controller associated with a first storage pool, and a second controller associated with a second storage pool. The first and second storage pools are illustratively storage pools of the distributed storage system 102, and such storage pools may be distributed across multiple ones of the storage nodes 105. Each of the first and second storage pools is assumed to comprise one or more LUNs or other logical storage volumes.

Although first and second controllers are referred to in conjunction with some embodiments herein, it is to be appreciated that more than two controllers can be implemented in a given target in order to support more than two storage pools.

A given one of the storage nodes 105 illustratively processes IO operations received from one or more of the hosts 101, with different ones of the IO operations being directed by the one or more hosts 101 from one or more initiators of the one or more hosts 101 to different ones of the first and second controllers of the target implemented within the given storage node. The other storage nodes 105 may each be configured to operate in a similar manner as the given storage node.

As indicated above, in some embodiments, multiple controllers are part of a single physical controller subsystem of the given storage node. For example, first and second controllers may comprise respective NVMe controllers of an NVMe subsystem of the given storage node. Such an NVMe subsystem is considered an example of what is more generally referred to herein as a “target” of the given storage node.

An example of such an arrangement will be described in more detail below in conjunction with FIG. 4. Other types of targets comprising multiple controllers supporting adaptive prioritization of background processes can be used in other embodiments.

The first and second controllers in some embodiments may be viewed as comprising respective “virtual” controllers associated with the single physical controller subsystem of the given storage node.

Additionally or alternatively, the first and second controllers in some embodiments are accessible via respective first and second different associations comprising one or more TCP connections between a given one of the one or more hosts 101 and the given storage node. In such an arrangement, a host accesses the first controller using the first association, and accesses the second controller using the second association. Other types of communication links can be used in other embodiments.

In some embodiments, the first controller comprises a first set of IO queues and the second controller comprises a second set of IO queues, for use in processing IO operations for their respective storage pools.

The above and other features of illustrative embodiments of system 100 are presented by way of example only, and should not be viewed as limiting in any way.

The manner in which functionality for adaptive prioritization of background processes is implemented in system 100 will now be described in more detail.

As indicated previously, conventional storage system arrangements often have difficulty balancing the handling of host IOs with additional IOs generated by one or more background processes, such as drive rebuild processes, garbage collection processes and/or replication processes, leading to potentially significant performance degradations.

Illustrative embodiments disclosed herein overcome these and other drawbacks of conventional practice by providing techniques for adaptive prioritization of background processes, as described below.

Such techniques advantageously facilitate the effective execution of background processes of various types in a manner that dynamically avoids interfering with proper execution of host IO operations. Accordingly, potentially significant performance degradations that might otherwise occur when executing one or more background processes are prevented, leading to improved overall performance.

Software-defined storage systems and other types of storage systems generally implement various background processes to maintain and reclaim storage and to perform other functionality. Such background processes include, for example, drive rebuild processes, garbage collection processes and/or replication processes. Other example background processes include RAID rebalancing processes, data scrubber processes, etc.

Host IO processing performance might degrade due to the execution of the background processes. For example, host IO performance measures such as IO operations per second (IOPS) and processing bandwidth may drop and processing latency may increase.

Illustrative embodiments provide adaptive prioritization techniques that allow background processes to be executed in a manner that has minimal impact on host IOs. In some embodiments, this involves dynamically adjusting an allowed rate of one or more background processes based at least in part on current system state.

These techniques recognize that some background processes need to complete faster than others. For example, in a RAID system, a drive rebuild process that returns the system from a degraded state to a protected state should complete faster than a data scrubber process that scans user data and metadata, validates checksums, and implements fixes if necessary. Also, within different RAID rebuild processes there may be different levels of priority. For example, in the case of RAID 6 with two failed drives, priority should be higher since another drive failure will result in data loss, and rebuild should complete fast enough to meet the system resiliency target (e.g. 99.9999%). As another example, a garbage collection process executing when the system is running out of storage capacity may need a higher priority in order to quickly free up additional storage capacity.

Although some embodiments are described herein in the context of IO-related background processes, which generally include any background process that causes additional IOs to be generated, the disclosed techniques are additionally or alternatively applicable to other types of background processes, including those that consume system resources (e.g., CPU, RAM, network bandwidth) but do not cause additional IOs to be generated.

Illustrative embodiments are effective in diversified hardware configurations (e.g., different numbers of CPU processing cores, different types and amounts of RAM, different network speeds, different storage device types, etc.) This is particularly advantageous as one or more bottlenecks for handling IOs could vary in different hardware setups between, for example, CPU, RAM, network, storage devices, etc.

Some embodiments provide adaptive prioritization of background processes based at least in part on one or more resource utilization policies. For example, some embodiments provide a dynamic and automatically adaptive resource utilization policy that can be applied to the background processes to adjust their prioritization.

This illustratively involves dynamically adjusting an allowed rate of one or more background processes based at least in part on current system state. For example, the respective rates of one or more background processes can be increased or decreased under specified conditions. This can include, as one illustration, detecting a current system state in which host IOs are running at a relatively low rate with lower than normal IOPS and bandwidth values, such that the system could potentially increase the allowed rates of one or more of the background processes. When the host IOs return to a normal rate with the normal IOPS and bandwidth values, the allowed rates of the one or more background processes can be decreased.

Minimum and/or maximum targets can be set for IOPS and bandwidth for each of one or more of the background processes in some embodiments, to meet customer requirements or other system needs.

In some embodiments, rate limits can be applied to limit IOPS and/or bandwidth per internal IO source of a storage system, and optionally also for host IOs generated by one or more hosts external to the storage system. The rate limits in some embodiments can illustratively include predefined or manually-defined target rates for each of a plurality of background processes of the storage system. Such target rates may be defined, for example, utilizing one or more of configuration files, configuration application programming interfaces (APIs), environment variables, etc.

Additionally or alternatively, the rate limits are dynamically adapted based at least in part on storage system state. For example, the storage system can monitor host IOs, background process IO utilization and other parameters of storage system state. The storage system utilizes the monitored storage system state parameters to automatically apply a policy for adaptive change of rate limits of one or more background processes. For example, in the case of RAID 6, with dual parity, when dual disk failures are detected, the policy can adaptively prioritize a RAID rebuild process by temporarily increasing its rate limit so that the storage system will be more quickly restored to a protected state.

In some embodiments, host IOs are given a higher priority than background process IOs under normal operation of the storage system. Additional IOs generated by one or more background processes of the storage system, illustratively referred to herein as “internal” IOs of the storage system, are generally limited to their respective target rates that allow them to progress sufficiently during normal operation of the storage system. The host IOs are illustratively referred to as “external” IOs.

The adaptive prioritization functionality in some embodiments comprises an adaptive rate limiter that monitors storage system state including host IO rates and internal IO rates, and under designated conditions provides a dynamic adjustment in at least one rate limit of at least one background process.

For example, a given background process that temporarily requires a higher priority, such as a garbage collection process to be executed as the storage system is nearing the end of its available storage capacity, has its rate limit automatically increased so as to make additional storage capacity available more quickly than would otherwise be possible. The resulting impact on other background processes and host IOs may then be handled, for example, by decreasing the priorities of the rest of the background processes so that the total priority of all the background processes remain the same, or by allowing the increase in the priority of the given background process to increase the total priority of all of the background processes in a manner that could potentially impact the host IOs.

In some embodiments, the storage system is configured to detect, illustratively as part of its ongoing monitoring of system state, a condition under which the host is temporarily generating IOs at relatively low IOPS and bandwidth values, relative to such values under normal operation, and to respond to such a detected condition by dynamically increasing the rate limits of one or more of the background processes. The storage system subsequently detects an indication that the host is returning to generating IOs at normal IOPS and bandwidth values, and responds to such a detected condition by reducing the previously-increased rate limits of one or more of the background processes.

The above-noted detection of changes in host IO generation can in some embodiments be based at least in part on an indication provided by the host, illustratively via associated host-side prioritization logic, to corresponding storage-side prioritization logic associated with one or more of the storage nodes. Additionally or alternatively, the storage system can monitor the IOPS and bandwidth values of the host, and possibly also additional performance measures such as IO latency, to detect an increased rate of IO generation at the host. Again, the storage system responds to such a detected condition by dynamically adjusting the rate limits of one or more background processes.

In some embodiments, the storage system will initially limit the total amount of bandwidth that can be consumed by the background processes to a first configured value, such as, for example, 50% of the median bandwidth, also referred to elsewhere herein as media IO usage. This can facilitate the rapid transition of background process IO generation back to lower rates responsive to detection of increased rates of host IO generation. For example, when the total amount of host IOs and background process IOs reaches a second configured value, such as 70% of the median bandwidth, the storage system can return the adaptive rates of the background processes to their respective normal values. The particular configured values can be adjusted by an administrator or other user, or may be hardcoded into the system as predefined values.

A more detailed example of the operation of the system 100 in accordance with the illustrative adaptive prioritization techniques introduced above will now be presented.

In some embodiments, the system 100 is configured to determine current state information of distributed storage system 102, where the current state information is indicative of at least an amount of IO operations being generated by at least one of the hosts 101 for delivery to the distributed storage system 102 over a network. The system 100 is further configured to dynamically adjust a rate at which one or more background processes are permitted to generate additional IO operations based at least in part on the current state information of the distributed storage system 102. Dynamically adjusting a rate at which one or more background processes are permitted to generate additional IO operations based at least in part on the current state information can include, for example, adjusting actual rates, adjusting rate limits and/or adjusting one or more other rate-related characteristics of the respective one or more background processes. These dynamic rate adjustments are considered examples of adaptive prioritization of background processes as disclosed herein.

Such functionality is illustratively performed primarily by at least portions of the distributed storage system 102, through cooperative interaction with at least one of the hosts 101 and possibly also one or more of the system managements nodes 110 and their associated control plane servers 112. One or more portions of the distributed storage system 102 implementing adaptive prioritization functionality may be viewed as an illustrative example of what is more generally referred to herein as “at least one processing device” comprising a processor coupled to a memory.

In some embodiments, the current state information indicates at least one of an IOPS measure and a bandwidth measure for the IO operations generated by at least one of the hosts 101. Such measures are illustratively indicative of an amount of IO operations being generated by at least one of the hosts 101, and the term “amount of IO operations” as used herein is intended to be broadly construed, and should not be viewed as being limited to actual numbers of IO operations or any other particular measures. Additional or alternative measures, parameters, indicators or other types of information can be used to characterize current state of the distributed storage system 102 in other embodiments.

Dynamically adjusting a rate at which one or more background processes are permitted to generate additional IO operations based at least in part on the current state information in some embodiments illustratively comprises modifying respective rate limits for one or more of the background processes.

In some embodiments, the current state information includes both an indication of the amount of IO operations being generated by at least one of the hosts 101 and respective additional indications of amounts of IO operations being generated by each of a plurality of background processes. Again, terms such as “amount of IO operations” and “amounts of IO operations” as used herein are intended to be broadly construed, and should not be viewed as being limited in any way to particular numbers of IO operations.

Various types of dynamic adjustments in rates at which one or more background processes are permitted to generate additional IO operations are illustratively implemented in prioritization logic of one or more of the storage processors 108.

By way of example, in some embodiments, responsive to a detected condition in which the amount of IO operations being generated by at least one of the hosts 101 is below a threshold, a rate at which at least one of a plurality of background processes is permitted to generate additional IO operations is dynamically increased.

As another example, in some embodiments, responsive to a detected condition in which the amount of IO operations being generated by at least one of the hosts 101 is above a threshold, a rate at which at least one of a plurality of background processes is permitted to generate additional IO operations is dynamically decreased.

These and other thresholds referred to herein can be configurable parameters of the distributed storage system 102, and can be set to particular values by administrators or other system users. It is also possible that such thresholds and/or other related parameters can be at least in part hard-coded or otherwise predefined.

Additionally or alternatively, dynamically adjusting a rate at which one or more background processes are permitted to generate additional IO operations based at least in part on the current state information in some embodiments comprises controlling amounts of IO operations being generated by respective ones of a plurality of background processes subject to a combined rate limit on the amount of IO operations being generated by at least one of the hosts 101 and the amounts of IO operations being generated by respective ones of the plurality of background processes.

The combined rate limit for the IO operations of at least one of the hosts and the plurality of background processes is set in some embodiments in terms of a percentage of a median bandwidth of IO operations for the distributed storage system 102 as determined over one or more monitoring periods. A wide variety of other types of individual or combined rate limits can be used in other embodiments. Again, such parameters can be at least in part hard-coded or otherwise predefined, and/or at least in part configurable by an administrator or other user.

As mentioned previously, the background processes can comprise, for example, drive rebuild processes, garbage collection processes, replication processes and/or other types of processes, as well as combinations of multiple instances of one or more of these and other background processes.

In some embodiments, a given one of the background processes comprises a drive rebuild process, the current state information includes an indication of whether or not a maximum number of failed drives has been reached, and dynamically adjusting a rate at which one or more background processes are permitted to generate additional IO operations based at least in part on the current state information comprises dynamically increasing a rate of the drive rebuild process based at least in part on the maximum number of failed drives being reached.

Additionally or alternatively, such an embodiment can dynamically increase a rate of the drive rebuild process based at least in part on an indication of how close the storage system is to the maximum number of failed drives.

It should be noted in this regard that the term “drive rebuild process” as used herein is intended to be broadly construed, so as to encompass, for example, any of a wide variety of different types of processes that are configured to reconstruct missing data based at least in part on a failure of at least a portion of at least one drive and/or storage node. For example, a drive rebuild process in some embodiments illustratively comprises a background process running in a software-defined storage system, where the background process automatically corrects the storage system responsive to a failure of a drive or a storage node, by rebuilding any missing portions of the stored data (e.g., by reconstructing the missing data in accordance with the particular RAID arrangement implemented within the storage system). Similar drive rebuild processes are utilized in storage systems that are neither software-defined nor distributed. The particular rebuild algorithm implemented in a given embodiment will typically vary depending upon the type and configuration of the storage system, but such storage systems generally include some type of background rebuild process to recover data resiliency after a failure.

As another example, a given one of the background processes in some embodiments comprises a garbage collection process, the current state information includes an indication of whether or not an amount of available storage capacity is below a threshold, and dynamically adjusting a rate at which one or more background processes are permitted to generate additional IO operations based at least in part on the current state information comprises dynamically increasing a rate of the garbage collection process based at least in part on the amount of available storage capacity being below the threshold.

As yet another example, a given one of the background processes in some embodiments comprises a replication process, the current state information includes an indication of whether or not an amount of time remaining to a replication deadline is below a threshold, and dynamically adjusting a rate at which one or more background processes are permitted to generate additional IO operations based at least in part on the current state information comprises dynamically increasing a rate of the replication process based at least in part on the amount of time remaining to the replication deadline being below the threshold.

Some embodiments disclosed herein advantageously provide significant improvements in dynamically adapting rates at which one or more background processes are permitted to generate IO operations while also efficiently managing host IO operations.

For example, if a storage system is heavily loaded, new host IO operations may be unduly delayed before such host IO operations can be generated at the host, much less reach the storage system. This may be due to the host being configured such that a first IO operation generated for a given application will have to be completed by the storage system and such completion acknowledged back to the host before a second IO operation is generated by the host for the given application. However, if the storage system is heavily loaded, the completion and acknowledgement of the first IO operation will be delayed, and therefore generation of the second IO operation will be delayed. This means that when the storage system is heavily loaded, the host may be unable to generate more IO operations, such that the storage system does not detect an increase in the host IO load, and it does not reduce the rates at which one or more background processes are permitted to generate IO operations. Illustrative embodiments disclosed herein address this issue and effectively prevent it from occurring. In some embodiments, this involves the host providing an indication to the storage system that it needs to increase the host IO rate but is unable to do so. Additionally or alternatively, it may involve the one or more background processes being prevented from increasing their IO rates beyond some maximum percentage of perceived system performance.

Numerous other types and arrangements of background processes, current state information and dynamic rate adjustments can be used in other embodiments.

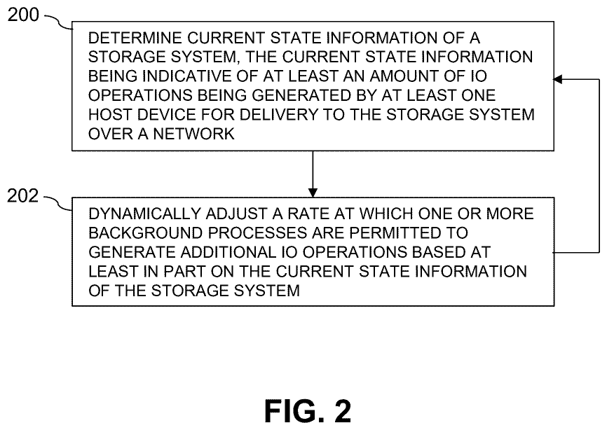

An additional example of an illustrative process for implementing at least some of the above-described adaptive prioritization functionality will be provided below in conjunction with the flow diagram of FIG. 2.

As indicated previously, the storage nodes 105 collectively comprise an example of a distributed storage system. The term “distributed storage system” as used herein is intended to be broadly construed, so as to encompass, for example, scale-out storage systems, clustered storage systems or other types of storage systems distributed over multiple storage nodes.

Also, the term “storage volume” as used herein is intended to be broadly construed, and should not be viewed as being limited to any particular format or configuration.

In some embodiments, the storage nodes 105 are implemented using processing modules that are interconnected in a full mesh network, such that a process of one of the processing modules can communicate with processes of any of the other processing modules. Commands issued by the processes can include, for example, remote procedure calls (RPCs) directed to other ones of the processes.

The sets of processing modules of the storage nodes 105 illustratively comprise control modules, data modules, routing modules and at least one management module. Again, these and possibly other processing modules of the storage nodes 105 are illustratively interconnected with one another in the full mesh network, such that each of the modules can communicate with each of the other modules, although other types of networks and different module interconnection arrangements can be used in other embodiments.

The management module in such an embodiment may more particularly comprise a system-wide management module, also referred to herein as a system manager. Other embodiments can include multiple instances of the management module implemented on different ones of the storage nodes 105.

A wide variety of alternative configurations of nodes and processing modules are possible in other embodiments. Also, the term “storage node” as used herein is intended to be broadly construed, and may comprise a node that implements storage control functionality but does not necessarily incorporate storage devices. As mentioned previously, a given storage node can in some embodiments comprise a separate storage array, or a portion of a storage array that includes multiple such storage nodes.

Communication links may be established between the various processing modules of the storage nodes using well-known communication protocols such as TCP/IP and RoCE. For example, respective sets of IP links used in data transfer and corresponding messaging could be associated with respective different ones of the routing modules.

The particular features described above in conjunction with FIG. 1 should not be construed as limiting in any way, and a wide variety of other system arrangements implementing adaptive prioritization of background processes as disclosed herein are possible.

The storage nodes 105 of the example distributed storage system 102 illustrated in FIG. 1 are assumed to be implemented using at least one processing platform, with each such processing platform comprising one or more processing devices, and each such processing device comprising a processor coupled to a memory. Such processing devices can illustratively include particular arrangements of compute, storage and network resources.

The storage nodes 105 may be implemented on respective distinct processing platforms, although numerous other arrangements are possible. At least portions of their associated hosts 101 may be implemented on the same processing platforms as the storage nodes 105 or on separate processing platforms.

The term “processing platform” as used herein is intended to be broadly construed so as to encompass, by way of illustration and without limitation, multiple sets of processing devices and associated storage systems that are configured to communicate over one or more networks. For example, distributed implementations of the system 100 are possible, in which certain components of the system reside in one data center in a first geographic location while other components of the system reside in one or more other data centers in one or more other geographic locations that are potentially remote from the first geographic location. Thus, it is possible in some implementations of the system 100 for different subsets of the hosts 101 and the storage nodes 105 to reside in different data centers. Numerous other distributed implementations of the storage nodes 105 and their respective associated sets of hosts 101 are possible.

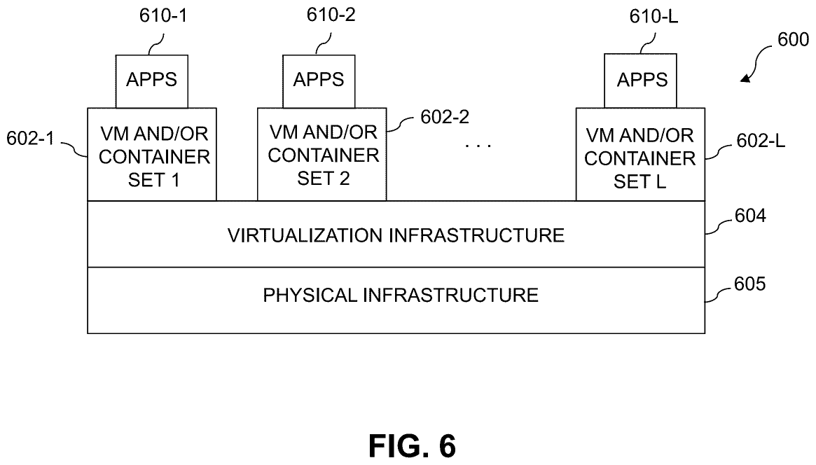

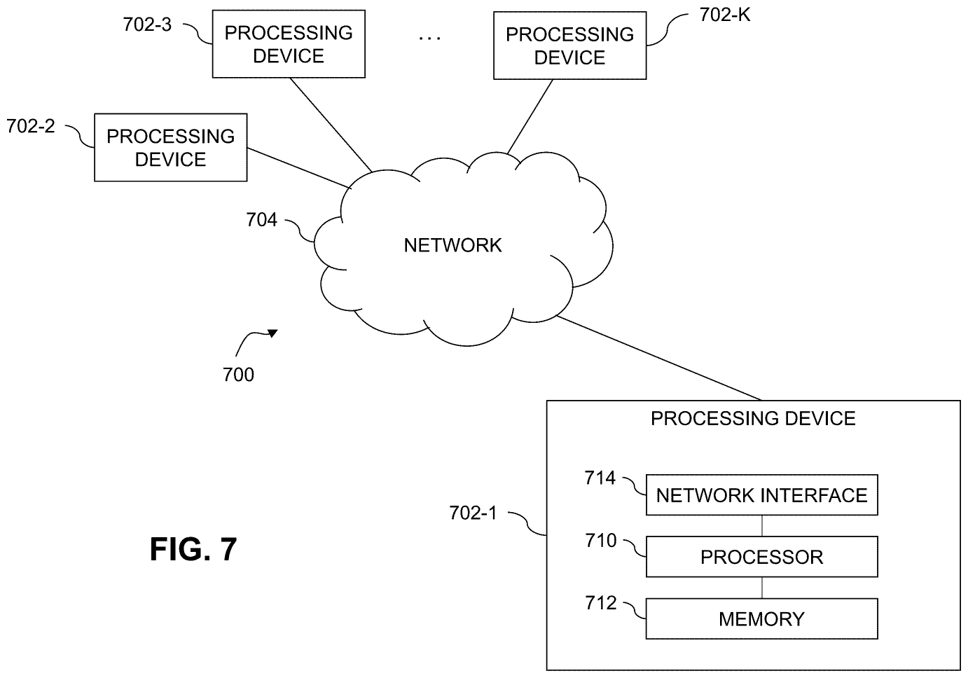

Additional examples of processing platforms utilized to implement storage systems and possibly their associated hosts in illustrative embodiments will be described in more detail below in conjunction with FIGS. 6 and 7.

It is to be appreciated that these and other features of illustrative embodiments are presented by way of example only, and should not be construed as limiting in any way.

Accordingly, different numbers, types and arrangements of system components such as hosts 101, distributed storage system 102, storage nodes 105, storage devices 106, storage processors 108, system management nodes 110 and instances of path selection logic 114 can be used in other embodiments. For example, as mentioned previously, system management functionality of system management nodes 110 can be distributed across a subset of the storage nodes 105, instead of being implemented on separate nodes.

It should be understood that the particular sets of modules and other components implemented in a distributed storage system as illustrated in FIG. 1 are presented by way of example only. In other embodiments, only subsets of these components, or additional or alternative sets of components, may be used, and such components may exhibit alternative functionality and configurations.

For example, in other embodiments, certain portions of adaptive prioritization functionality as disclosed herein can be implemented in one or more hosts, in a storage system, or partially in a host and partially in a storage system. Accordingly, illustrative embodiments are not limited to arrangements in which adaptive prioritization functionality is implemented primarily in a storage system or primarily in a particular host or set of hosts, and therefore such embodiments encompass various alternative arrangements, such as, for example, an arrangement in which the functionality is distributed over one or more storage systems and one or more associated hosts, each comprising one or more processing devices. The term “at least one processing device” as used herein is therefore intended to be broadly construed.

The operation of the information processing system 100 will now be described in further detail with reference to the flow diagram of the illustrative embodiment of FIG. 2, which illustrates a process for adaptive prioritization of background processes as disclosed herein. This process may be viewed as an example algorithm implemented at least in part by distributed storage system 102 interacting with one or more of the hosts 101. These and other algorithms for adaptive prioritization of background processes as disclosed herein can be implemented using other types and arrangements of system components in other embodiments.

The process illustrated in FIG. 2 includes steps 200 through 202, and is assumed to be implemented primarily by the distributed storage system 102 interacting with one of the hosts 101, although other arrangements are possible.

In step 200, current state information of a storage system is determined, the current state information being indicative of at least an amount of IO operations being generated by at least one host device for delivery to the storage system over a network. The current state information in some embodiments can indicate, for example, an amount of IO operations being generated by the host device and possibly also amounts of IO operations being generated by each of a plurality of background processes. Such information can be obtained, for example, at least in part from the host device, such as via an MPIO driver or other component thereof, and/or using a performance monitor or other component of the storage system. Various types of measures such as IOPS and/or bandwidth can be used as indicators of the amounts of IO operations being generated, for example, for a given monitoring period. Additional or alternative indicators, measures, parameters and/or other information can be part of the “current state information” as that term is broadly used herein, and the term should therefore not be construed as being limited to information associated with one or more particular points in time, but may instead encompass, for example, state information relating to at least parts of a given monitoring period. Accordingly, current state information can encompass, for example, state information gathered over at least parts of a most recent monitoring period.

In step 202, a rate at which one or more background processes are permitted to generate additional IO operations is dynamically adjusted based at least in part on the current state information of the storage system. For example, if the current state information indicates that the host device is generating IOs at a significantly below-normal rate, the one or more background processes may have their rates temporarily adjusted upward in a manner that does not interfere with the host IO operations. Such upward rate adjustments are illustratively subject to a combined rate limit of host IOs and background process IOs, in order to ensure that a buffer of sufficient available bandwidth remains so that the upward rate adjustments can be quickly reversed should the host device return to generating IOs at its normal rate.

Steps 200 through 202 are illustratively repeated periodically over time in order to support the adaptive prioritization functionality. Multiple such processes may operate in parallel with one another in order to provide adaptive prioritization functionality for different host devices and/or storage systems.

The steps of the FIG. 2 process are shown in sequential order for clarity and simplicity of illustration only, and certain steps can at least partially overlap with other steps. Additional or alternative steps can be used in other embodiments.

The particular processing operations and other system functionality described in conjunction with the flow diagram of FIG. 2 are therefore presented by way of illustrative example only, and should not be construed as limiting the scope of the disclosure in any way. Alternative embodiments can use other types of processing operations for implementing adaptive prioritization of background processes for one or more hosts and a storage system. For example, as indicated above, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement a plurality of different processes for respective different hosts and/or storage systems.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.” One or more hosts and/or one or more storage nodes can be implemented as part of what is more generally referred to herein as a processing platform comprising one or more processing devices each comprising a processor coupled to a memory.

A given such processing device in some embodiments may correspond to one or more virtual machines or other types of virtualization infrastructure such as Docker containers or Linux containers (LXCs). Hosts, storage processors and other system components may be implemented at least in part using processing devices of such processing platforms. For example, respective path selection logic instances and other related logic instances of the hosts can be implemented in respective containers running on respective ones of the processing devices of a processing platform.

Additional examples of illustrative embodiments will now be described with reference to FIGS. 3, 4 and 5.

FIG. 3 shows another example system 300 incorporating functionality for adaptive prioritization of background processes in an illustrative embodiment. The system 300 includes at least one IO source 301 and a plurality of layers including an IO persistency layer 306, an IO processing layer 308 and a control layer 310. The system 300 may be viewed as comprising one possible configuration of a software-defined storage system with adaptive prioritization functionality, but as indicated previously numerous other storage system configurations can be used in implementing the disclosed techniques. For example, the system 300 illustratively comprises one or more hosts that collectively form at least a portion of the IO source 301, as well as a storage system that is assumed to comprise at least the IO persistency layer 306, the IO processing layer 308 and the control layer 310, and may further comprise a non-host portion of the IO source 301.

Accordingly, the IO source 301 can comprise at least a portion of at least one host and possibly one or more additional or alternative components. For example, the IO source 301 can comprise a storage data client (SDC) and/or a storage data target (SDT) in some embodiments. The IO source 301 is illustratively assumed to initiate IO operations and to send the IO operations to the IO processing layer 308. The IO source 301 can therefore comprise at least portions of one or more of the hosts 101 of the FIG. 1 embodiment. As indicated previously, host IOs in some embodiments are also referred to herein as “external” IOs, as they originate externally to the storage system, while one or more background processes of the storage system illustratively generate what are referred to herein as “internal” IOs. The IO source 301 is illustratively viewed as generating both internal and external IOs. Other types and arrangements of IO sources can be used in other embodiments.

The IO processing layer 308 handles the incoming IO operations from the IO source 301, including by way of example performing functions such as compression, deduplication, write cache maintenance, metadata updates, RAID parity calculations, etc. Most or all of the background processes in a given embodiment can be carried out at least in part under the control of the IO processing layer 308. The IO processing layer 308 includes multiple IO processing logic instances as shown, each illustratively associated with a different storage node. The IO processing layer 308 can comprise, for example, at least portions of one or more of the storage processors 108 of the FIG. 1 embodiment.

The IO persistency layer 306 handles writing and reading of data to and from local persistent storage devices such as storage devices 106 in the FIG. 1 embodiment. It includes multiple IO persistency logic instances as shown, which may be part of respective different storage nodes, and each is associated with a different set of local persistent storage devices.

The control layer 310 handles management of the storage system and performs functions such as configuring the storage system and maintaining metadata. It includes multiple control logic instances as shown, illustratively comprising respective different control logic instances for managing the IO source 301, the IO processing layer 308 and the IO persistency layer 306. The control layer 310 can comprise, for example, at least portions of one or more of the storage processors 108 and/or at least portions of one or more of the control plane servers 112 of the FIG. 1 embodiment.

In operation, the IO source 301 initiates IO operations such as write and read requests that are sent to the IO processing layer 308 over one or more networks not explicitly shown. The IO processing layer 308 receives the IO operations from the IO source 301, and as part of the handling of those IO operations calls the IO persistency layer 306 in order to write data to and read data from the appropriate local storage devices.

As previously described herein, the storage system determines current state information, where the current state information is indicative of at least an amount of IO operations being generated by at least one host device for delivery to the storage system, and dynamically adjusts a rate at which one or more background processes are permitted to generate additional IO operations based at least in part on the current state information of the storage system.

For example, in some embodiments, the control layer 310 may obtain at least portions of the current state information, such as current IO usage indications or other information indicative of amounts of IO operations currently being generated, from respective storage nodes of the storage system. It may also receive IO usage indications from one or more hosts that are part of the IO source 301.

Responsive to detecting that the host IO rate drops below a threshold, the control layer 310 illustratively indicates to the IO processing layer 308 and possibly also the IO persistency layer 306, that the rates of one or more background processes should be increased, up to a specified rate limit.

Responsive to detecting that the host IO rate returns to a normal rate above the threshold, the control layer 310 illustratively indicates to the IO processing layer 308 and possibly also the IO persistency layer 306, that the rates of one or more background processes should be decreased back to their respective normal rates, that is, the rates that were in place prior to the previous rate increase.

These and other embodiments are configured to ensure that the increased rates temporarily allocated to the one or more background processes will not prevent the available bandwidth from being too fully occupied with background process IOs. In other words, a buffer is provided, such that the storage system can quickly reverse the increased background process rates and return to processing the host IOs at their normal rate.

This buffer is illustratively implemented by the control layer 310 initially restricting the total background process IO usage at the increased background process rates to no more than a specified percentage of the median IO usage, such as 50% of the median IO usage. In such an arrangement, when the total usage of the host IOs and the background process IOs reaches a specified combined limit, such as 70% of the median IO usage, the control layer 310 reverses the previous increase in the background process rates. The host IO rates can therefore always have sufficient available bandwidth to quickly ramp back up to normal levels.

Additionally or alternatively, in some embodiments, the IO source 301 comprises a kernel module or other component of a host device, that is configured to report its IO usage and other related information to the control layer 310. Such information is considered part of the “current state information” of the storage system, as that term is broadly used herein. Such a report allows the control layer 310 to quickly respond to an indication of an increased host IO rate by returning the background process rates back to their normal levels.

It is to be appreciated that the particular system configuration shown in FIG. 3, like other system configurations disclosed herein, is presented by way of illustrative example only, and is not to be construed as limiting in any way. Other examples are described below in conjunction with FIGS. 4 and 5.

Referring now to FIG. 4, this embodiment illustrates an example of a distributed storage system that more particularly comprises a software-defined storage system having a plurality of software-defined storage server nodes, also referred to as SDS server nodes, configured to utilize an NVMe storage access protocol such as NVMe-oF or NVMe/TCP. Such SDS server nodes are examples of “storage nodes” as that term is broadly used herein. As will be appreciated by those skilled in the art, similar embodiments can be implemented without the use of software-defined storage and with other storage access protocols.

As shown in FIG. 4, an information processing system 400 comprises a host 401 configured to communicate over a network 404, illustratively a TCP/IP network, with a software-defined storage system comprising a plurality of SDS server nodes 405-1, 405-2, . . . 405-M and corresponding control plane servers 412. The control plane servers 412 are shown in dashed outline as the functionality of such servers in illustrative embodiments is distributed over a particular subset of the SDS server nodes 405 rather than being implemented on separate nodes of the software-defined storage system. The control plane servers 412 provide system management functionality such as centralized storage provisioning, monitoring, membership management, as well as storage partitioning.

A plurality of applications 411 execute on the host 401 and generate IO operations that are delivered to particular ones of the SDS server nodes 405 via at least one NVMe initiator 418. The host 401 further comprises path selection logic 414, and may additionally include host-side prioritization logic, not explicitly shown in the figure, but illustratively configured to carry out host-side aspects of adaptive prioritization functionality of the system 400 in a manner similar to that previously described. In other embodiments, the host-side prioritization logic may be part of the path selection logic 414, rather than a separate component. Both the path selection logic 414 and any associated host-side prioritization logic in some embodiments are implemented at least in part within an MPIO driver of the host 401. Although only a single host 401 is shown in system 400, the system 400 can include multiple hosts, each configured as generally shown for host 401, as in the system 100 of FIG. 1.

Each of the SDS server nodes 405 in the present embodiment comprises at least one NVMe target 420, a data relay agent 421, a data server 422 and a set of local drives 423. The internal components of a given SDS server node with the exception of the local drives 423 are illustratively part of a corresponding storage processor in the FIG. 1 embodiment, although numerous other arrangements are possible. Each of the SDS server nodes 405 may additionally include storage-side prioritization logic, also not explicitly shown in the figure, but illustratively configured to carry out storage-side aspects of adaptive prioritization functionality of the system 400 in a manner similar to that previously described.

The data relay agent 421 facilitates relaying of IO requests between different ones of the SDS server nodes 405, and the data servers 422 provide access to data stored in the local drives 423 of their respective SDS server nodes 405. Additional or alternative components may be included in the SDS server nodes 405 in illustrative embodiments.

Although single NVMe initiators and targets are shown in respective ones of the host 401 and the SDS server nodes 405, this is by way of simplified illustration only, and other embodiments can include multiple NVMe initiators within host 401 and multiple NVMe targets within each of the SDS server nodes 405.

In some embodiments, the SDS server nodes 405 are configured at least in part as respective PowerFlex® software-defined storage nodes from Dell Technologies, suitably modified as disclosed herein to include adaptive prioritization functionality, although other types of storage nodes can be used in other embodiments.

The NVMe targets 420 in some embodiments collectively comprise an NVMe subsystem that implements multiple distinct controllers and associated adaptive prioritization of background processes. For example, a given such NVMe target can comprise at least a first controller associated with a first storage pool of the distributed storage system, and a second controller associated with a second storage pool of the distributed storage system. Other types and arrangements of multiple controllers can be used.

A given one of the SDS server nodes 405 processes IO operations received from the host 401, with different ones of the IO operations being directed by the host 401 from NVMe initiator 418 to different ones of the first and second controllers of the NVMe target 420 of the given SDS server node.

In implementing the disclosed adaptive prioritization functionality, the storage system utilizes the above-noted storage-side prioritization logic, possibly with interaction with the corresponding host-side prioritization logic, to determine current state information, where the current state information is indicative of at least an amount of IO operations being generated by at least one host device for delivery to the storage system, and to dynamically adjust a rate at which one or more background processes are permitted to generate additional IO operations based at least in part on the current state information of the storage system, in the manner described in more detail elsewhere herein.

In other embodiments of the system 400, the host 401 may be configured to run an SDC, illustratively as a kernel module, that exposes logical storage volumes to system users, and that communicates with the SDS server to perform IO operations, without using the NVMe storage access protocol. The SDC and/or SDS server can collect IO processing statistics and other performance measures and provide them to one or more control plane servers 412 or other management servers of the system 400. Again, this is only an example arrangement, and numerous other system configurations can be used.

Referring now to FIG. 5, another illustrative embodiment is shown. In this embodiment, an information processing system 500 comprises host-side elements that include application processes 511, path selection logic 514 and prioritization logic 515, and storage-side elements that include system state monitor 521 and prioritization logic 522. The path selection logic 514 is configured to operate in conjunction with prioritization logic 515, system state monitor 521 and prioritization logic 522 to implement functionality for adaptive prioritization of background processes in the system 500. There may be separate instances of one or more such elements associated with each of a plurality of system components such as hosts and storage arrays of the system 500. For example, different instances of the path selection logic 514 are illustratively implemented within or otherwise in association with respective ones of a plurality of MPIO drivers of respective hosts.

The system 500 is configured in accordance with a layered system architecture that illustratively includes a host processor layer 530, an MPIO layer 532, a host port layer 534, a switch fabric layer 536, a storage array port layer 538 and a storage array processor layer 540. The host processor layer 530, the MPIO layer 532 and the host port layer 534 are associated with one or more hosts, the switch fabric layer 536 is associated with one or more SANs or other types of networks, and the storage array port layer 538 and storage array processor layer 540 are associated with one or more storage arrays (“SAs”). A given such storage array illustratively comprises a software-defined storage system or other type of distributed storage system comprising a plurality of storage nodes.

In a manner similar to that described elsewhere herein, one or more storage arrays of the system 500 are each configured to determine current state information, where the current state information is indicative of at least an amount of IO operations being generated by at least one host device for delivery to the storage array, and to dynamically adjust a rate at which one or more background processes are permitted to generate additional IO operations based at least in part on the current state information of the storage array.

For example, a given storage array via a corresponding instance of the system state monitor 521 determines the current state information. This can include interaction with host-side prioritization logic 515 of the MPIO layer 532 to identify significant increases and decreases in the rates at which host IOs are generated by one or more host devices. The storage-side prioritization logic 522 illustratively obtains the current state information from the system state monitor 521 and dynamically adjusts the rates at which one or more background processes are permitted to generate IOs, as previously described.

The system 500 in this embodiment therefore implements adaptive prioritization functionality utilizing one or more MPIO drivers of the MPIO layer 532, and associated instances of path selection logic 514 and prioritization logic 515, as well as the system state monitor 521 and the prioritization logic 522.

The one or more storage arrays also process IO operations received from one or more hosts, with different ones of the IO operations being directed by the one or more hosts under the control of path selection logic 514 from one or more initiators of the one or more hosts to different ones of the first and second controllers of the target in a given storage array.

A given one of the hosts of the system 500 is illustratively configured to establish a plurality of paths between at least one initiator (e.g., an NVMe initiator) of the given host and a plurality of targets (e.g., NVME targets) of respective storage nodes. For each of a plurality of IO operations generated by one or more of the application processes 511 in the given host for delivery to the given storage array, the given host selects, illustratively via path selection logic 514 of one or more MPIO drivers of the MPIO layer 532, a particular one of the plurality of paths from the initiator to one of the targets on the particular storage node, and sends the IO operation to the particular storage node over the selected path.

The application processes 511 generate IO operations that are processed by the MPIO layer 532 for delivery to the one or more storage arrays that collectively comprise a plurality of storage nodes of a distributed storage system. Paths are determined by the path selection logic 514 for sending such IO operations to the one or more storage arrays, utilizing discovery information previously obtained by initiators of the one or more hosts. These IO operations are sent to the one or more storage arrays in accordance with one or more scheduling algorithms, load balancing algorithms and/or other types of algorithms.

The MPIO layer 532 is an example of what is also referred to herein as a multi-path layer, and comprises one or more MPIO drivers implemented in respective hosts. Each such MPIO driver illustratively comprises respective instances of path selection logic 514 and prioritization logic 515 configured as previously described. Additional or alternative layers and logic arrangements can be used in other embodiments.

As mentioned above, in the system 500, path selection logic 514 is configured to select different paths for sending IO operations from a given host to a storage array. These paths as illustrated in the figure include a first path from a particular host port denoted HP1 through a particular switch fabric denoted SF1 to a particular storage array port denoted SP1, and a second path from another particular host port denoted HP2 through another particular switch fabric denoted SF2 to another particular storage array port denoted SP2.

These two particular paths are shown by way of illustrative example only, and in many practical implementations there will typically be a much larger number of paths between the one or more hosts and the one or more storage arrays, depending upon the specific system configuration and its deployed numbers of host ports, switch fabrics and storage array ports. For example, each host in the FIG. 5 embodiment can illustratively have the same number and type of paths to a shared storage array, or alternatively different ones of the hosts can have different numbers and types of paths to the storage array.

The path selection logic 514 of the MPIO layer 532 in this embodiment selects paths for delivery of IO operations to the one or more storage arrays having the storage array ports of the storage array port layer 538. More particularly, the path selection logic 514 determines appropriate paths over which to send particular IO operations to particular logical storage devices of the one or more storage arrays.

Some implementations of the system 500 can include a relatively large number of hosts (e.g., 1000 or more hosts), although as indicated previously different numbers of hosts, and possibly only a single host, may be present in other embodiments. Each of the hosts is typically allocated a sufficient number of host ports to accommodate predicted performance needs. In some cases, the number of ports per host is on the order of 4, 8 or 16, although other numbers of ports could be allocated to each host depending upon the predicted performance needs. A typical storage array may include on the order of 128 ports, although again other numbers can be used based on the particular needs of the implementation. The number of hosts per storage array port in some cases can be on the order of 10 hosts per port.

A given host of system 500 can be configured to initiate an automated path discovery process to discover new paths responsive to updated zoning and masking or other types of storage system reconfigurations performed by a storage administrator or other user. For certain types of hosts, such as hosts using particular operating systems such as Windows, ESX or Linux, automated path discovery via the MPIO drivers of a multi-path layer is typically supported. Other types of hosts using other operating systems such as AIX in some implementations do not necessarily support such automated path discovery, in which case alternative techniques can be used to discover paths.

These and other features of illustrative embodiments disclosed herein are examples only, and should not be construed as limiting in any way. Other types of adaptive prioritization of background processes can be used in other embodiments, and terms such as “adaptive prioritization” and “background processes” as used herein are therefore intended to be broadly construed.

The above-described illustrative embodiments can provide significant advantages over conventional approaches.

For example, some embodiments provide techniques for adaptive prioritization of background processes, in a software-defined storage system or other type of distributed storage system, although the disclosed techniques are more broadly applicable to a wide variety of other types of storage systems.

The disclosed techniques in some embodiments advantageously facilitate the effective execution of background processes of various types in a manner that dynamically avoids interfering with proper execution of host IO operations.

Accordingly, potentially significant performance degradations that might otherwise occur when executing one or more background processes are prevented, leading to improved overall performance.

The disclosed techniques provide significant advantages over conventional arrangements such as sockets, queues, backpressure and round robin or weighted round robin (WRR) selection of IOs, but in some embodiments can be configured to operate in conjunction with such arrangements.

Furthermore, illustrative embodiments can be implemented without requiring any change in any storage access protocol specification.

Moreover, these and other embodiments can help to improve overall system performance, for example, by providing an improved balancing of IO operations generated by one or more background processes with IO operations generated by one or more hosts.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement hosts and distributed storage systems with adaptive prioritization functionality will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that may be utilized to implement at least a portion of the information processing system 100. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 may comprise respective VMs, respective sets of one or more containers, or respective sets of one or more containers running in VMs.

In some implementations of the FIG. 6 embodiment, the VMs/container sets 602 comprise respective VMs implemented using virtualization infrastructure 604 that comprises at least one hypervisor. Such implementations can provide adaptive prioritization functionality in a distributed storage system of the type described above using one or more processes running on a given one of the VMs. For example, each of the VMs can implement logic instances and/or other components for implementing functionality associated with adaptive prioritization of background processes in the system 100.

A hypervisor platform may be used to implement a hypervisor within the virtualization infrastructure 604. Such a hypervisor platform may comprise an associated virtual infrastructure management system. The underlying physical machines may comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system. Such implementations can also provide adaptive prioritization functionality in a distributed storage system of the type described above. For example, a container host supporting multiple containers of one or more container sets can implement logic instances and/or other components for implementing functionality associated with adaptive prioritization of background processes in the system 100.

As is apparent from the above, one or more of the processing devices or other components of system 100 may each run on a computer, server, storage device or other processing platform element. A given such element may be viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 702-1 in the processing platform 700 comprises a processor 710 coupled to a memory 712.

The processor 710 may comprise a microprocessor, a microcontroller, an application-specific integrated circuit (ASIC), a field-programmable gate array (FPGA), graphics processing unit (GPU) or other type of processing circuitry, as well as portions or combinations of such circuitry elements.

The memory 712 may comprise random access memory (RAM), read-only memory (ROM), flash memory or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise various arrangements of converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the adaptive prioritization functionality provided by one or more components of a storage system as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, hosts, storage systems, storage nodes, storage devices, storage processors, initiators, targets, path selection logic instances, prioritization logic instances and additional or alternative components. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to determine current state information of a storage system, the current state information being indicative of at least an amount of input-output operations being generated by at least one host device for delivery to the storage system over a network; and
to dynamically adjust a rate at which one or more background processes are permitted to generate additional input-output operations based at least in part on the current state information of the storage system.

2. The apparatus of claim 1 wherein the at least one processing device comprises at least a portion of the storage system.

3. The apparatus of claim 1 wherein the storage system comprises a distributed storage system that includes a plurality of storage nodes.

4. The apparatus of claim 3 wherein the distributed storage system comprises a software-defined storage system and the storage nodes comprise respective software-defined storage server nodes of the software-defined storage system.

5. The apparatus of claim 1 wherein the current state information indicates at least one of an input-output operations per second (IOPS) measure and a bandwidth measure for the input-output operations generated by the at least one host device.

6. The apparatus of claim 1 wherein dynamically adjusting a rate at which one or more background processes are permitted to generate additional input-output operations based at least in part on the current state information comprises modifying respective rate limits for one or more of the background processes.

7. The apparatus of claim 1 wherein the current state information includes an indication of the amount of input-output operations being generated by the at least one host device and respective additional indications of amounts of input-output operations being generated by each of a plurality of background processes.

8. The apparatus of claim 7 wherein responsive to a detected condition in which the amount of input-output operations being generated by the at least one host device is below a threshold, a rate at which at least one of the plurality of background processes is permitted to generate additional input-output operations is dynamically increased.

9. The apparatus of claim 7 wherein responsive to a detected condition in which the amount of input-output operations being generated by the at least one host device is above a threshold, a rate at which at least one of the plurality of background processes is permitted to generate additional input-output operations is dynamically decreased.

10. The apparatus of claim 1 wherein dynamically adjusting a rate at which one or more background processes are permitted to generate additional input-output operations based at least in part on the current state information comprises controlling amounts of input-output operations being generated by respective ones of a plurality of background processes subject to a combined rate limit on the amount of input-output operations being generated by the at least one host device and the amounts of input-output operations being generated by respective ones of the plurality of background processes.

11. The apparatus of claim 10 wherein the combined rate limit for the input-output operations of the at least one host device and the plurality of background processes is set in terms of a percentage of a median bandwidth of input-output operations for the storage system as determined over one or more monitoring periods.

12. The apparatus of claim 1 wherein a given one of the background processes comprises a drive rebuild process, the current state information includes an indication of whether or not a maximum number of failed drives has been reached, and dynamically adjusting a rate at which one or more background processes are permitted to generate additional input-output operations based at least in part on the current state information comprises dynamically increasing a rate of the drive rebuild process based at least in part on the maximum number of failed drives being reached.

13. The apparatus of claim 1 wherein a given one of the background processes comprises a garbage collection process, the current state information includes an indication of whether or not an amount of available storage capacity is below a threshold, and dynamically adjusting a rate at which one or more background processes are permitted to generate additional input-output operations based at least in part on the current state information comprises dynamically increasing a rate of the garbage collection process based at least in part on the amount of available storage capacity being below the threshold.

14. The apparatus of claim 1 wherein a given one of the background processes comprises a replication process, the current state information includes an indication of whether or not an amount of time remaining to a replication deadline is below a threshold, and dynamically adjusting a rate at which one or more background processes are permitted to generate additional input-output operations based at least in part on the current state information comprises dynamically increasing a rate of the replication process based at least in part on the amount of time remaining to the replication deadline being below the threshold.

15. A computer program product comprising a non-transitory processor-readable storage medium having stored therein program code of one or more software programs, wherein the program code when executed by at least one processing device comprising a processor coupled to a memory, causes the at least one processing device:
to determine current state information of a storage system, the current state information being indicative of at least an amount of input-output operations being generated by at least one host device for delivery to the storage system over a network; and
to dynamically adjust a rate at which one or more background processes are permitted to generate additional input-output operations based at least in part on the current state information of the storage system.

16. The computer program product of claim 15 wherein dynamically adjusting a rate at which one or more background processes are permitted to generate additional input-output operations based at least in part on the current state information comprises modifying respective rate limits for one or more of the background processes.

17. The computer program product of claim 15 wherein responsive to a detected condition in which the amount of input-output operations being generated by the at least one host device is below a threshold, dynamically increasing a rate at which at least one of a plurality of background processes is permitted to generate additional input-output operations.

18. A method comprising:
determining current state information of a storage system, the current state information being indicative of at least an amount of input-output operations being generated by at least one host device for delivery to the storage system over a network; and
dynamically adjusting a rate at which one or more background processes are permitted to generate additional input-output operations based at least in part on the current state information of the storage system;
wherein the method is performed by at least one processing device comprising a processor coupled to a memory.

19. The method of claim 18 wherein dynamically adjusting a rate at which one or more background processes are permitted to generate additional input-output operations based at least in part on the current state information comprises modifying respective rate limits for one or more of the background processes.

20. The method of claim 18 wherein responsive to a detected condition in which the amount of input-output operations being generated by the at least one host device is below a threshold, dynamically increasing a rate at which at least one of a plurality of background processes is permitted to generate additional input-output operations.
